(19) United States
(12) Patent Application Publication
(10) Pub. No.: US 2003/0074760 A1
(43) Pub. Date: Apr. 24, 2003

(54) Paint applicator system

(75) Inventor: Russell D. Keller, Vancouver, WA (US)

Correspondence Address: Kolisch, Hartwell, Dickinson, McCormack & Heuser, 200 Pacific Building, 520 S.W. Yamhill Street, Portland, OR, 97204, US

(73) Assignee: RDK Company

(21) Appl. No.: 10/045,487

(22) Filed: Oct. 19, 2001

(51) Int. Cl. B05C 17/02

(52) U.S. Cl. 15/230.11; 15/257.06; 492/13; 492/19

(57) ABSTRACT

A paint application system configured for applying paint to the interior surfaces within a gap between spaced-apart boards. The system typically includes a disk, or disks, extending radially from an outer surface of a cylindrical paint roller. Also included may be a paint wring-out device having grooves or slots for squeezing excess paint from the disk, or disks.

### FIELD OF THE INVENTION

The present invention relates to an apparatus for applying paint to surfaces within a gap between spaced-apart boards.

### BACKGROUND OF THE INVENTION

Devices for applying paint to a surface and into corners have been known for many years. The need for applying paint quickly and with minimum effort to large areas led to the development of paint rollers. Paint rollers have the advantage of being able to apply a wide swath of paint, reducing the time needed to paint a large surface, such as an interior wall.

However, paint rollers are not well suited for applying paint to irregular surfaces, particularly, surfaces having small radius curves, gaps, ribs, or crevices. For example, it is desirable to be able to apply paint to a fence or deck where adjacent boards are spaced apart at regular intervals. Rollers may be used to apply paint to the exposed surface of adjacent boards, but cannot be used to apply paint to the two facing surfaces of spaced-apart boards. Previously, to apply paint within such a gap required a conventional hand brush, which was very labor intensive. Therefore, it would be desirable to provide a paint applicator system for applying paint to both the exterior surface as well as the surfaces within the gap between spaced-apart boards in a less labor-intensive manner.

### SUMMARY OF THE INVENTION

A paint application system for applying paint to the interior surfaces within a gap between spaced-apart boards. The system typically includes at least one disk extending radially from an outer surface of a cylindrical paint roller, a paint-carrier material covering the disk. A paint wring-out device may also be included. That device would typically have at least one groove or slot for squeezing excess paint from the disk.

### BRIEF DESCRIPTION OF THE DRAWINGS

FIG. 1 is an isometric view of a paint application system according to one embodiment of the present invention including a roller application and a roller paint pan having a liner adapted to work with the roller.

FIG. 2 is an exploded isometric view of the paint application system of FIG. 1.

FIG. 3 is an end elevation sectional view of the paint pan and tray insert pan liner adapted to work with the roller applicator of FIG. 1, taken along line 3-3 of FIG. 1.

FIG. 4 is an end elevation sectional view corresponding to FIG. 3, except that FIG. 4 depicts a second embodiment of a paint pan adapted to work with the roller applicator of FIG. 1.

FIG. 5 is a top plan view of the roller applicator of FIG. 1.

FIG. 6 is a sectional view of the roller of the roller applicator of FIG. 5, taken along line 6-6 of FIG. 5, showing the construction of the roller with disks configured to slide over the roller.

FIG. 7 is a sectional view corresponding to FIG. 6, except that FIG. 7 depicts an alternate embodiment of the roller disk where the disks are formed integrally with the roller.

FIG. 8 is a sectional view corresponding to FIG. 6, except that FIG. 8 depicts a second alternate embodiment of a roller and disks, showing the disks sandwiched between adjacent roller segments.

FIG. 9 is a top plan view of a paint application system according to another embodiment of the present invention, having a shortened roller and a single disk.

FIG. 10 is a top plan view of a paint application system according to another embodiment of the present invention, having a standard roller and three disks.

FIG. 11 is a top plan view of a paint application system according to another embodiment of the present invention, having a standard roller and four disks.

FIG. 12 is a schematic view of a roller applicator according to one of the embodiments of the present invention, shown applying paint to a picket fence.

FIG. 13 is a schematic view of a roller applicator according to one of the embodiments of the present invention, shown applying paint to a sheet of T-1-11 siding.

FIG. 14 is a schematic view of a roller applicator according to one of the embodiments of the present invention, shown applying paint to the adjacent boards of a deck.

FIG. 15 is an isometric view of a roller applicator according to one of the embodiments of the present invention, shown applying paint to a cylindrical railing.

FIG. 16 is a side view of a disk adapter according to one embodiment of the present invention.

FIG. 17 is a cross-sectional view of the adapter of FIG. 16 taken along line 17-17 of FIG. 16.

FIG. 18 is a cross-sectional view of another embodiment of a disk adapter according to one embodiment of the present invention.

FIG. 19 is an isometric view of a paint pan and wring-out insert tray according to one embodiment of the present invention.

FIG. 20 is an end view of the wring-out insert tray of FIG. 19.

### DETAILED DESCRIPTION OF THE PREFERRED EMBODIMENTS

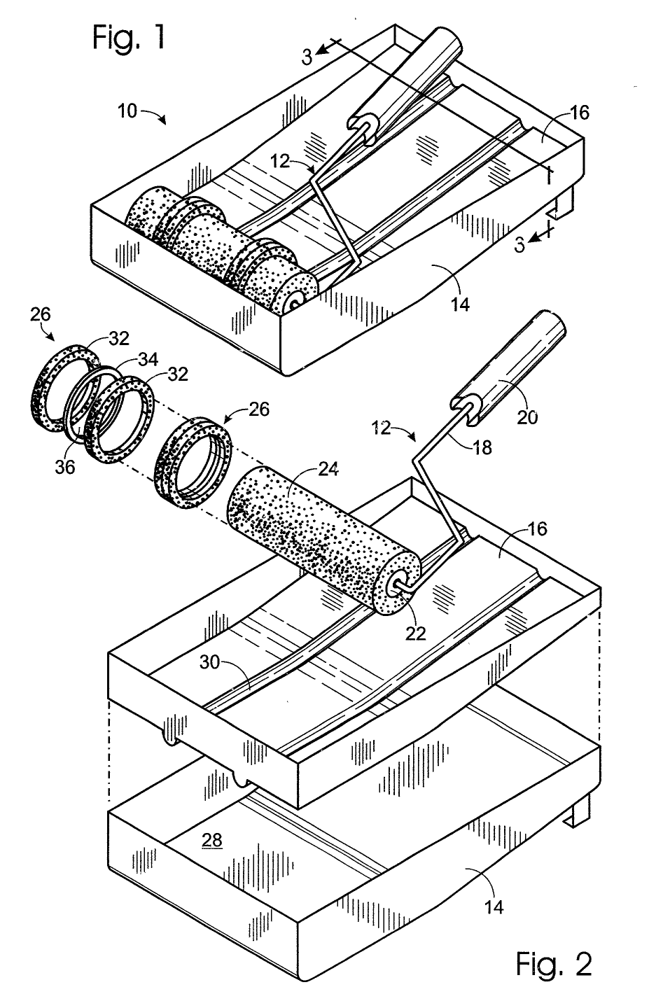

In FIG. 1, a preferred embodiment of a paint application system according to the present invention is indicated generally at 10. The paint application system includes a paint applicator 12, a paint roller pan 14, and a tray insert 16, shown in FIG. 2. Roller applicator 12 is configured to apply paint to exterior surfaces, and interior surfaces within a gap or crevice, as will be explained further below. Paint roller pan 14 holds paint for loading paint onto applicator 12. Tray insert 16 removes excess paint from applicator 12.

Roller applicator 12 includes a frame 18 configured to support a handle 20 and a roller-carrier structure 22. Handle 20 permits a user to manipulate applicator 12. Roller-carrier structure 22 supports a paint roller 24 and is configured to rotate about an axis, as will be explained in detail below. Paint roller 24 is generally cylindrical in shape and may be configured to support adapter disks 26.

Adapter disks 26 may be configured to slide over roller 24 and be positioned along the length of the roller. Disks 26 are configured to extend radially beyond an exterior surface of roller 24 so that disks 26 may be used to apply paint to the facing surfaces of adjacent but spaced boards.

Paint roller pan 14 includes a paint-loading portion 28 configured to hold a volume of paint to be loaded onto applicator 12. Paint is loaded onto applicator 12 by dipping roller 24 into paint-loading portion 28 of paint roller pan 14. Excess paint is removed from roller 24 by rolling it across tray insert 16. Tray insert 16 includes wring-out structure 30 configured to remove the excess paint from adapter disks 26. Wring-out structure 30 may be in the form of grooves or channels in insert 16, sized to accommodate disks 26. Excess paint is squeezed out from the disks by wring-out structure 30 as the roller is rolled along insert 16.

Disks 26 may include a paint-carrier material 32 designed to hold paint and apply it evenly to interior surfaces of a gap. Paint-carrier material 32 may be a nap material, similar to the material that typically covers a paint roller, or any other suitable material capable of carrying paint, such as open-celled foam, felt, sponge, etc. Disks 26 may be supported by a rigid core structure 34, as shown in FIG. 2. Rigid core structure 34 enables paint-carrier material 32 to be inserted in a tight gap without folding over on itself, or wadding up, thereby improving the application of paint to the surfaces within the gap. Rigid core structure 34 typically includes an aperture 36, which may be sized to accommodate the circumference of roller 24 or roller-carrier structure 22, as will be explained below.

Paint-carrier material 32 substantially covers the outer surface of disk 26. In one embodiment paint-carrier material extends radially beyond the rigid core structure 34. Paint may be applied to the bottom surface of a groove or crevice by the paint-carrier material extending beyond the rigid core.

Turning to FIG. 3, cross-sections of paint roller pan 14 and tray insert 16 are shown taken along line 3-3 of FIG. 1. It can be seen that wring-out structure 30 of insert tray 16 is in the form of grooves sized to accommodate disks 26 and is spaced above bottom 38 of pan 14.

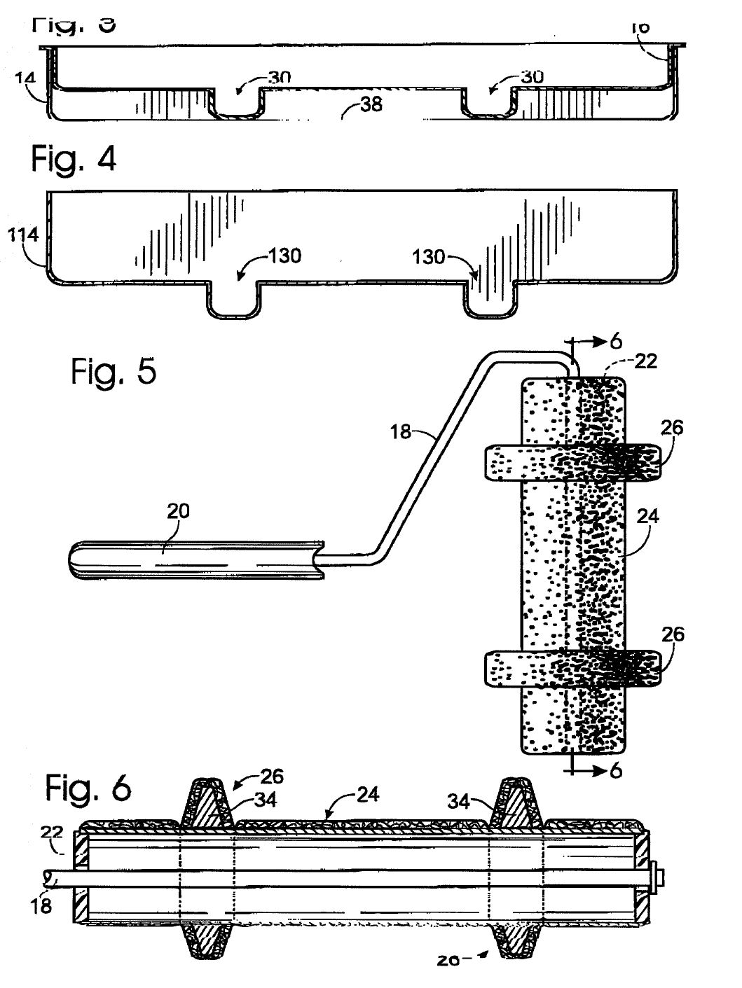

Another embodiment of a paint roller pan according to the present invention is shown in FIG. 4, generally indicated at 114. Paint roller pan 114 includes integral wring-out structure 130, eliminating the need for a tray insert.

Turning to FIG. 5 an assembled paint applicator 12 is shown. Handle 20 of applicator 12 enables a user to manipulate the roller assembly. The cylindrical roller 24 may be mounted opposite the handle on roller-carrier structure 22 and configured to apply paint to a surface using a rolling motion. As shown, applicator 12 includes roller 24 and disks 26.

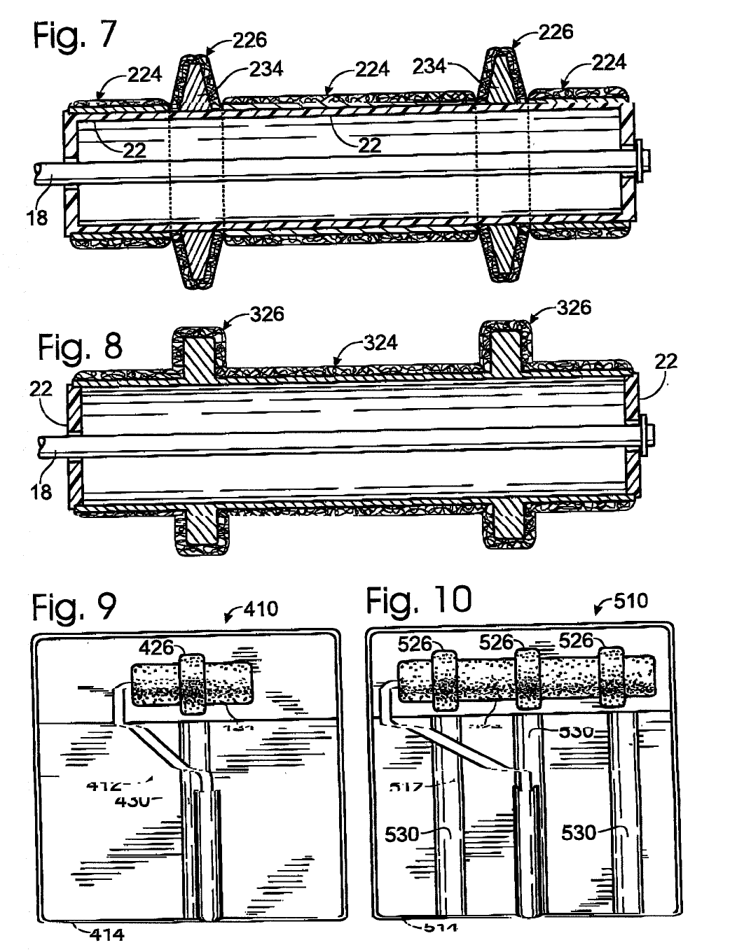

Consistent with the present invention, roller 24 and disks 26 may be constructed in several ways, as shown in FIGS. 6-8. FIG. 6 is a sectional view of roller 24 and disks 26 taken along line 6-6 of FIG. 5. FIGS. 7 and 8 correspond to FIG. 6, except that they each illustrate a different embodiment of the roller and disk structures of the present invention.

Turning again to FIG. 6, the depicted embodiment includes frame 18 extending along an axis of rotation for roller-carrier structure 22. Roller-carrier structure 22 supports paint roller 24 and at least one adapter disk 26. For example, two adapter disks 26 are shown positioned along the length of roller 24. Each adapter disk 26 engages the outer surface of roller 24 and may be positioned anywhere along the length of the roller. Disk 26 may engage roller 24 frictionally, or there may be teeth or a similar structure to grip roller 24. Flexibility in positioning adapter disks 26 along the length of roller 24 enables paint application system 10 to be used with a variety of board widths. That is, disks 26 are not fixed in position in the embodiment of FIG. 6. The may be positioned anywhere along the length of roller 24, to correspond to the width and spacing of the boards or other surfaces to be painted. While it may appear in FIG. 6 that there is no nap material under disks 26, that material is merely in compression due to the tight fit of the disks on roller 24.

Turning to FIG. 7, another embodiment of the present invention is depicted. Frame 18 and roller-carrier structure 22 are similar to that shown in FIG. 6, but paint roller 224 is in three sections. Adapter disks 226 are sandwiched between each adjacent section of paint roller 224. Rigid core 234 of disk 226 includes an aperture sized to slide over roller-carrier structure 22. Therefore, in the embodiment depicted in FIG. 7, adapter disks 226 are supported directly by roller-carrier structure 22 instead of by the roller. That is, there is no nap material that is compressed beneath disks 226. The segments of roller 224 may be sized lengthwise to permit a pair of adapter disks 226 to be positioned on roller-carrier structure 22 with a predefined space between them that corresponding to the width of the boards to be painted. Roller segments 224 may be of a predefined length to precisely control the spacing between adapters 226. In this manner the spacing between the adapters may be precisely matched to the width of the boards being painted.

As an alternative to what is shown in FIG. 7, segments of roller 224 could be any suitable size. For example, segments may be sized to approximately half the length of roller-carrier structure 22, therefore accommodating a single adaptor disk 226.

Turning to FIG. 8, still another embodiment of applicator 12 is shown. In the depicted embodiment, roller-carrier structure 22 and frame 18 are identical to the embodiments shown in FIGS. 6 and 7. However, disks 326 of this embodiment are formed integrally with roller 324 as a single part adapted to slide into place over carrier structure 22. The space between disks 326 is fixed in this configuration, and accidental loss of the disks is prevented.

Turning to FIGS. 9-11 three different embodiments of the present invention are shown. Different embodiments may be useful for a variety of specific painting applications as shown in FIGS. 12-15. The embodiments shown are examples of some of the embodiments useful for a variety of applications and are not meant to be limiting.

In the embodiment of FIG. 9, a paint applicator system 410 includes an applicator 412 having a shortened roller 424 and a single adapter disk 426. The depicted embodiment may be useful for apply paint to a picket fence, as shown in FIG. 12. Additionally, this embodiment may be useful for applying paint to a cylindrical railing surface, as shown in FIG. 15.

In the embodiment of FIG. 10, a paint applicator system 510 is shown. Paint applicator system 510 includes an applicator 512 having a roller 524 that includes three adapter disks 526. This embodiment may be useful for painting gaps between boards having a relatively small width. Employing three adapter disks speeds the application of paint to the internal surfaces of three adjacent gaps. It should be understood that as many adapter disks 26 may be used in the present invention as might be required to achieve the desired paint application task.

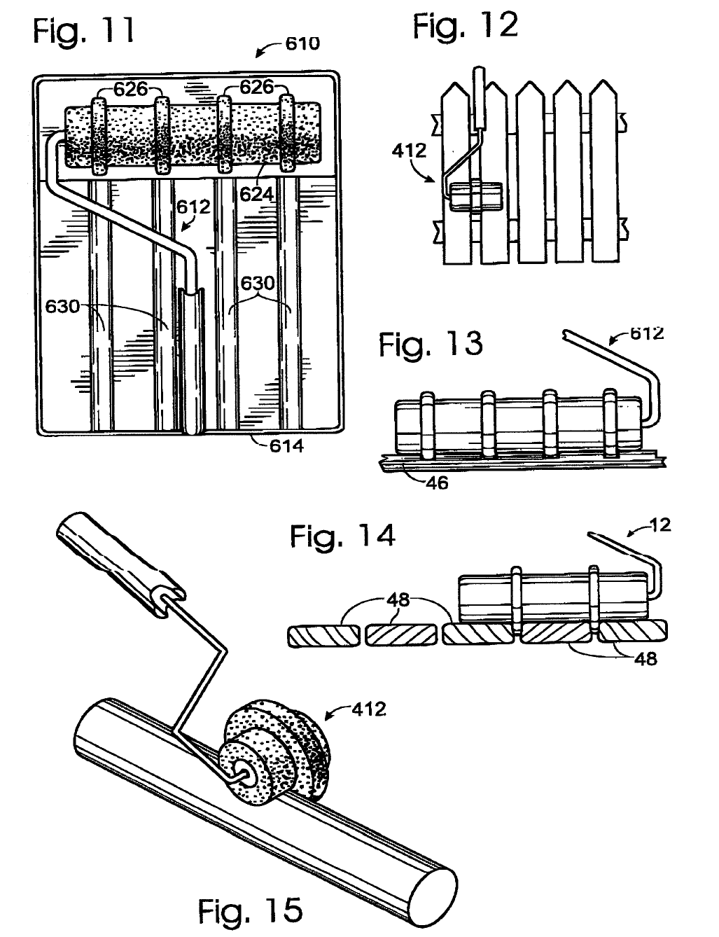

In the embodiment of FIG. 11, a paint applicator system 610 is shown having an applicator 612. Applicator 612 includes four adaptor disks 626 on roller 624. The size of disks 626 and the spacing between each disk may be adapted to standard size paneling and siding. For example, the spacing may be configured to apply paint to T-1-11 type siding and paneling. Application of paint using applicator 612 to T-1-11 siding is shown in FIG. 13.

FIG. 14 shows paint applicator 12 applying a stain or sealant to the boards 46 of a deck. The spacing between adjacent disks 26 is sized to accommodate the width of boards 46 so that the facing sides of the boards may be coated. Sealing and staining a deck is important for maintaining the deck and preventing dry rot and deterioration. Often the facing surfaces of adjacent boards are neglected in deck maintenance because of the difficulty in applying sealant to those surfaces. The use of application system 10 ensures that the surfaces of deck boards that are hard to reach with conventional brushes and rollers are efficiently and quickly sealed.

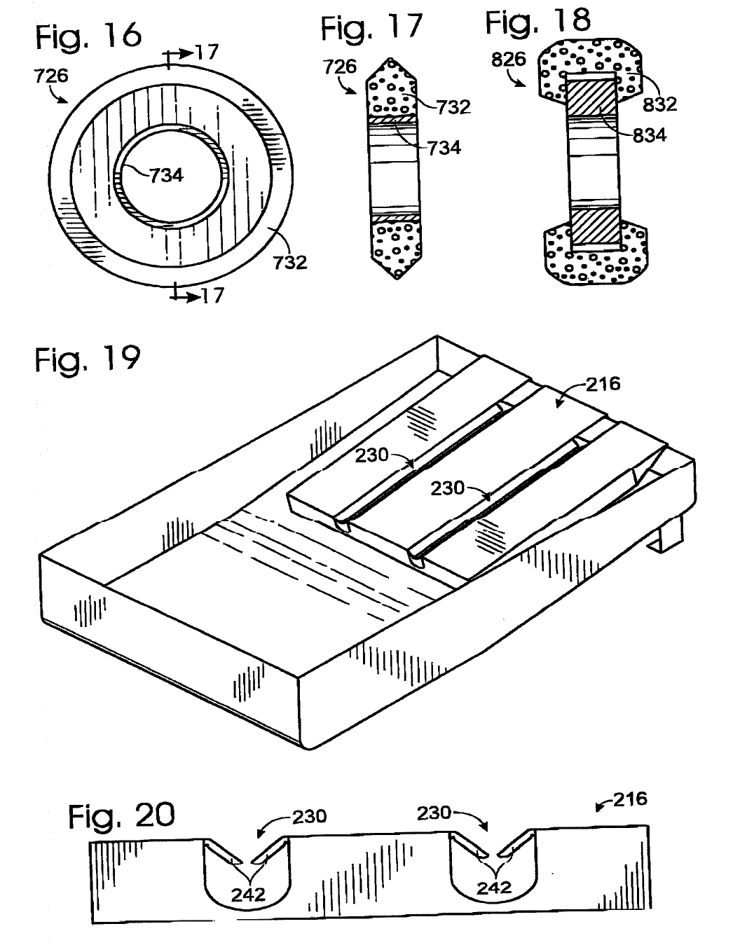

In addition to the various configurations of rollers and disks shown in FIGS. 6-8, various disk structures are contemplated by the present invention. Turning to FIGS. 16 and 17, a disk 726 according to an embodiment of the present invention is shown. Disk 726 may include a rigid core 734 that acts like a hub for a paint carrier material 732. Paint carrier material 732 may be open-cell foam or similar quasi-rigid material capable of carrying paint for application to surfaces within the gap between spaced-apart boards. Typically, paint carrier material 732 and rigid core 734 are manufactured together through a molding process. Alternatively, paint carrier material 732 may be secured to core 734 by an adhesive.

A sectional view of another embodiment of an adaptor disk according to the present invention is shown in FIG. 18, generally indicated at 826. Disk 826 includes a core 834 with larger dimensions and a paint-carrier material 832 that wraps around core 834 and is secured with an adhesive. As can be seen in FIG. 18, paint-carrier material 832 has a U-shaped cross section. It should be understood that other geometric configurations of disks might be desirable for various paint application tasks.

Another embodiment of a tray insert 216 is shown in FIGS. 19 and 20. As shown tray insert 216 only covers a portion of paint roller pan 14. Tray insert 216 includes a wring-out structure 230 having at least one channel or groove. Wring-out structure 230 may include squeeze blades 242, which are mounted to the sides of the grooves of wring-out structure 230. Squeeze blades 242 are adapted to remove the excess paint from adaptor disks 26 with a squeegee-type action. Blades 242 may be formed integrally with insert 216 or may be secured to the insert with an appropriate adhesive.

It should be understood that insert trays 16 and 216 may be made of any suitable material such as plastic or metal. Insert trays 16 and 216 may include apertures, or a web like structure for allowing paint to flow back down into paint filling portion 28 of roller paint pan 14.

The use of paint application system 10 may be better understood by way of example. Typically, a user prepares paint applicator 12 for the painting task by sliding two adapter disks 26 over roller 24 and adjusting the space between the adapter disks to be equal to the width of the boards of a deck. The user then slides roller 24, with disks 26 in place, over roller-carrier structure 22. Next the user inserts tray insert 16 into paint roller pan 14 and fills the pan with paint, or a sealant, or stain. The user next dips the roller end of applicator 12 into paint filling portion 28 of pan 14 and rolls it over wring-out structure 30 of tray insert 16 to remove any excess paint. Finally, a user aligns disks 26 with the gaps between adjacent boards of a deck, inserts the disks in the gap and rolls applicator 12 back and forth along the boards. Disks 26 rotate down between adjacent boards through the gaps, and apply paint to the surfaces within the gaps. The user may repeat these steps until the entire deck has been painted or sealed.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. An adaptor for use with a cylindrical shaped paint roller, having an external surface and a length, the adaptor comprising:
a disk having an aperture sized to circumscribe the paint roller and to extend radially beyond the external surface of the paint roller, wherein the disk is configured to slide along the length of the paint roller in frictional engagement therewith; and
a paint-carrier material covering at least a portion of the disk.

2. The adaptor of claim 1, wherein the paint-carrier material includes nap substantially covering the exterior of the disk.

3. The adaptor of claim 1, wherein the disk is sized to fit between a pair of spaced-apart boards and includes a rigid core structure.

4. An applicator for surface coatings comprising:
a roller having a substantially cylindrical shape including an outer surface;
a frame having a roller-carrier structure configured to receive the roller and rotate about an axis and a handle structure; and
a disk portion configured to extend radially beyond the outer surface of the roller, wherein the disk has a thickness less than half the length of the roller.

5. The applicator of claim 4, wherein the disk is formed integral with the roller-carrier structure.

6. The applicator of claim 4, wherein the disk is formed integral with the roller.

7. The applicator of claim 4, wherein the disk includes an aperture sized to frictionally engage the outer surface of the roller and be positioned along the length of the roller in frictional engagement therewith.

8. The applicator of claim 4, wherein the roller includes roller segments having a length less than the length of the roller-carrier structure and the disk includes an aperture sized to accommodate the roller-carrier structure and be positioned on the roller-carrier structure interposed adjacent roller segments.

9. The applicator of claim 4, wherein a nap material substantially covers the exterior surface of the roller.

10. The applicator of claim 4, wherein the disk includes a nap material substantially covering the exterior surface of the disk.

11. The applicator of claim 10, wherein the nap material extends radially beyond a core section of the disk.

12. The applicator of claim 4, further including a plurality of disks positionable along the length of the roller.

13. The applicator of claim 12, wherein the plurality of disk are spaced-apart a user selectable predefined distance such that each disk may be inserted between adjacent spaced-apart boards.

14. The applicator of claim 13, wherein the thickness of the nap material substantially covering the disk is sized to fit within the space between the spaced-apart boards.

15. The applicator of claim 14, wherein the spaced-apart predefined distance is sized for planks in a deck.

16. The applicator of claim 14, wherein the spaced-apart predefined distance is sized for pickets of a fence.

17. A kit for applying surface coatings to a space between adjacent spaced-apart boards comprising:
a roller having a substantially cylindrical shape and a nap substantially covering the outer surface of the roller; and
a disk portion adjustably coupled with the roller extending radially beyond the outer surface of the roller.

18. The kit of claim 17, wherein the disk includes an aperture in its center configured to slide over the roller for positioning along the length of the roller.

19. The kit of claim 18, further comprising:
a tray insert configured to fit within a roller paint pan and having a recessed groove sized to accommodate the disk.

20. The kit of claim 19, further comprising:
a plurality of disks each having an aperture in its center sized to accommodate a cylindrical roller and configured to slide over the roller and extend radially therefrom;
and wherein the tray insert includes a plurality of recessed grooves sized to accommodate the plurality of disks.

21. A paint roller pan comprising:
a paint loading portion; and
a wring-out structure including at least one recessed groove sized to accommodate at least one disk extending radially beyond exterior surface of a cylindrical paint roller.

22. The wring-out device of claim 21, wherein the plurality of grooves are spaced-apart at user-selectable predefined intervals.

23. The paint roller pan of claim 21, wherein the wring-out structure is a removable insert for the paint roller pan.
